(19) United States
(12) Patent Application Publication
(10) Pub. No.: US 2025/0289233 A1
(43) Pub. Date: Sep. 18, 2025

(54) Arrangement for guiding ink from and/or to one or more printheads of an ink jet printing system

(71) Applicant: CANON KABUSHIKI KAISHA, Tokyo (JP)

(72) Inventors: Bartholomeus T.G. PAULUS, Grubbenvorst (NL); Florian HITZLSPERGER, Poing (DE); Christoph RUMMELSBERGER, Ismaning (DE); Ulrich STOCKLE, Germering (DE); Jan A. VAN DER BOS, Beuningen (NL)

(21) Appl. No.: 19/075,004

(22) Filed: Mar. 10, 2025

(30) Foreign Application Priority Data
Mar. 12, 2024 (DE) 10 2024 000 818.7

(51) Int. Cl. B41J 2/175; B41J 3/54

(52) U.S. Cl. CPC B41J 2/17596; B41J 2/17566; B41J 3/543; B41J 2002/17579

(57) ABSTRACT

An arrangement for directing ink from/to printheads of an ink jet printing system. The arrangement has printheads and an ink guiding device adapted to direct ink from/to the printheads. The ink guiding device has partial guide housings, a connecting piece that connects underneath each partial guide housing with the print heads in an ink-guiding manner, a horizontal connector connecting a first partial guide housing at a first horizontal end in an ink-guiding manner to an ink supply, and a horizontal end piece closing a last partial guide housing at a second horizontal end. Each partial guide housing has a volume that can be filled partly with ink and partly with gas.

### CROSS-REFERENCE TO RELATED APPLICATIONS

This application claims priority to German Patent Application No. 10 2024 000 818.7 filed Mar. 12, 2024, all of which is incorporated by reference herein in its entirety.

### BACKGROUND

### Field of the Disclosure

The disclosure relates to an arrangement for guiding ink from and/or to one or more print heads of a system for ink jet printing.

### Description of the Related Art

Ink printing devices can be used for printing a printing material or recording medium. Such systems for ink jet printing operate, for example, according to the drop-on-demand principle. These have one or more print heads provided with nozzle units including ink channels and activators. The activators can, controlled by a printer control, excite ink drops in the direction of the recording medium, which are directed onto the recording medium in order to apply printing dots for a printed image there. The activators can generate ink drops thermally or piezoelectrically. When ink is supplied and/or discharged to one or more print heads or away from one or more print heads of an ink-jet printing system, a great challenge is to design ink guidance in such a way that sufficient ink arrives in each print head with a correct pressure and a correct flow rate and, at the same time, pressure waves cannot continue during the ejection of ink in such a way that they can exert a disturbing influence on neighboring print heads, for example by the formation of bubbles or by a pressure wave attenuating the action of an adjacent activator in such a way that the desired ink drop is not ejected. Known solutions are generally not scalable, so that a new supply or removal of ink must be designed for each new printing system. These feeds or discharges or distribution systems are also called manifolds.

An exemplary supply or supply arrangement can be constructed in accordance with U.S. Pat. Appl. No. 2012/0140003. Print bars are provided here, which are connected to a distributor. The distributors are in turn connected to a back pressure tank in which ink is arranged under pressure, so that ink can be transported into the distributors. The back pressure tank is also connected to a reservoir for ink via a pump and a filter. Ink is pumped from the storage tank into the back-pressure tank when the ink level in the back-pressure tank has dropped below a set level. For this purpose, the ink level in the back pressure tank can be measured. The ink in the reservoir can be supplemented with the aid of a pump from an ink bottle. The ink in the back pressure tank can be degassed. For this purpose, a degassing unit is provided that has a known degassing means and a pump. With the aid of the pump, ink is pumped back from the back-pressure tank via the degassing means into the back-pressure tank and degassed in the process. In this case, the back pressure tank continues to act as a cushioning effect on pressure waves continuing from the print head.

U.S. Pat. Appl. No. 2022/0234360 A1 discloses so-called base plates that are formed of metal and on which the print heads are mounted. The base plates have bores for feed and discharge, through which the ink is passed. A scalability of ink feeds and ink drains is described here, since the base plates can be mounted on one another in such a way that the bores can be joined together in a fluid-tight manner. This arrangement has, above all, the advantage of good heat conduction between print heads and ink guides. However, the problem of bubbling and the continuation of pressure waves is not addressed here.

U.S. Pat. Appl. No. 2,018/0,215, 167 discloses that an ink supply or a distribution system or a manifold that is connected to a plurality of print heads can be connected in a scalable manner to further manifolds. Here too, the problem of bubble formation and the continuation of pressure waves is not addressed separately.

### SUMMARY OF THE DISCLOSURE

A simplified solution for ink supply and/or removal from or to a print head is sought, which combines scalability with the cushioning of disturbances due to pressure waves of ink ejections.

The disclosure relates to an arrangement for guiding ink from and/or to one or more print heads of an ink-jet printing system. Said arrangement includes one or more print heads and at least one ink-guiding device. The at least one ink-guiding device is arranged to direct ink from and/or to the one or more print heads. The ink guiding device has a plurality of partial guide housings including a first partial guide housing and a last partial guide housing. It further has at least one lower connecting piece in each case, which connects underneath each partial guide housing with one or more print heads in ink-guiding manner. In addition, it has a horizontal connecting piece which connects the first partial guide housing at a first horizontal end in ink-guiding manner to an ink supply and/or an ink discharge. The ink guiding device also has a horizontal end piece that closes off the last partial guide housing at a second horizontal end.

The partial guide housings each have a volume that can be filled in part with ink and in part with air or another gas, an ink filling level and a gas pressure being adjustable. At its second horizontal end, each partial guide housing is connected to the first horizontal end of a further partial guide housing in an ink and gas connection or is connected to the horizontal end piece.

By connecting each partial guide housing at its second horizontal end to a first horizontal end of a further partial guide housing or an end piece in an ink guiding and gas guiding manner, wherein each partial guide housing has at least one lower connecting piece which connects underneath each partial guide housing with one or more print heads scalability is achieved, because an optional number of partial guide housings may be put together each having a lower connecting piece. Additionally, the specific construction of the ink guide device functions as damper for progressing pressure waves.

The ink guiding device can be provided for the ink supply or for the ink discharge. Also two ink guide devices my be provided, one for the ink supply and one for the ink discharge.

In particular, a volume of the ink guiding device is designed such that pressure waves which continue from the print head to the ink guiding device are cushioned. This is advantageous since in this way a function of the back-pressure tank from the prior art is assumed by the ink guiding device.

In a particularly advantageous embodiment, the partial guide housings can be connected to one another by means of seals at their horizontal ends and/or by means of seals with the horizontal connecting piece and/or by means of seals with the horizontal end piece. This is advantageous since in this way a particularly simple scalability can be achieved.

However, it is also conceivable for the partial guide housings to be welded to one another or formed integrally together and/or to be welded or formed integrally together with the horizontal connecting piece and/or with the horizontal end piece. In this way, a particularly good seal and robustness is ensured, whereby the scalability is also maintained due to the design.

The partial guide housings preferably have a parallelepiped shape, a horizontal width extension being in particular smaller than a vertical extension. This is advantageous since this is a particularly simple form in order to fulfill all the specifications mentioned so far.

In particular, the partial guide housings of the arrangement together have a volume of between 500 ml and 3.5 liter. The volume is preferably set up to be filled with ink between 30 and 70% and to be filled with gas, in particular air, up to 30 to 70%. In this way, the condition that pressure waves that continue from the print head to the ink guiding device are cushioned is particularly preferably fulfilled.

A cross-section of the ink guiding device is in particular between 15 and 35 mm in width and between 60 and 100 mm in height.

In a preferred embodiment, the partial guide housings are made of plastic. This is particularly inexpensive and easy to produce. However, it is also conceivable for the partial guide housings to be made of metal, in particular stainless steel.

In particular, the ink guiding device has one or more sensors for determining an ink filling level, in particular a capacitive filling level sensor. This is advantageous since simple control is made possible in this way.

In an advantageous embodiment, the ink guiding device has one or more sensors for determining a gas pressure. This is advantageous since a simple control is also made possible with this.

In particular, a filling level height is set to a certain value in a starting phase of a control so that a ratio between air and ink in the ink guiding device is correct. Furthermore, the filling level height is preferably measured so that there is no idling or overfilling of the ink guiding device.

Preferably, an ink-guiding device designed as an ink supply has a horizontal connecting piece which is connected in ink-guiding manner to a proportional valve which regulates a passage ink velocity as a function of the gas pressure. This is advantageous since a good ink supply is provided in this way. At a constant ink flow rate through the print heads, a fixed opening value is thus established at the proportional valve. When the printheads starts printing, more ink is needed. The pressure in the ink guiding device decreases in this case. This is then compensated by the proportional valve by opening it further.

In particular, a control unit is provided for controlling the proportional valve, which control unit is coupled to the sensors for determining the gas pressure and to the sensors for determining the gas pressure. The control unit is preferably set up to carry out the setting of the filling level in the starting phase during each maintenance operation, which is the case in an embodiment approximately after between 1.5 and 3.5 hours in each case.

In an advantageous embodiment, the at least one lower connecting piece of each partial guide housing connects the ink-guiding device with between one and three print heads, particularly preferably with two print heads. This is advantageous since this combines a good symmetry with a still sufficient pressure wave attenuation.

### BRIEF DESCRIPTION OF THE DRAWINGS

Further embodiments and advantages result from the drawings and the detailed description of the figures.

FIG. 1 shows a perspective exploded view of a component of an embodiment of an arrangement according to the disclosure.

FIG. 2 shows a schematic flow diagram representation of another embodiment of an arrangement according to the disclosure.

FIG. 3 shows a perspective exploded view of a part of a further advantageous embodiment of an arrangement.

FIG. 4 shows a perspective view of a part of a further advantageous embodiment of an arrangement.

### DESCRIPTION OF THE EMBODIMENTS

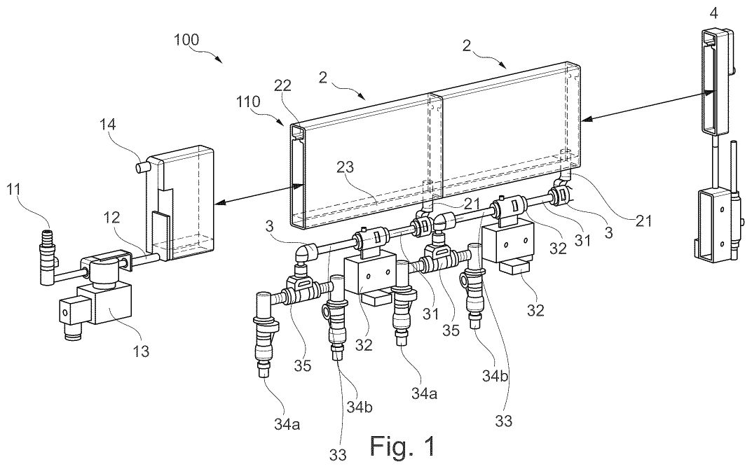

FIG. 1 shows a perspective exploded view of a component of an embodiment of an arrangement according to the disclosure for guiding ink from and/or to one or more print heads of a system for ink jet printing and is denoted by 100.

The printheads are not shown in this view. An ink guiding device 110 is shown that is arranged here to direct ink to a plurality of print heads. In this view, two partial guide housings 2 are shown. These have a parallelepiped shape and are made of a plastic. A horizontal width dimension is clearly smaller here than a vertical dimension. A length of the partial guide housing 2 is here adapted to a spacing of the print heads.

A lower connecting piece 3 is provided on each of the two partial guide housings 2 and connects the lower connecting piece 3 below each partial guide housing 2 to two print heads in ink-guiding manner. Each connecting piece 3 has a first section 31 that is below from a lower outlet 21 of the partial guide housing 2 to a connecting valve 32. Furthermore, each connecting piece 3 has a second section 33 that leads to a T-piece 35. The T-piece 35 distributes the pressure from the connecting valve 32 incoming ink on two printhead leads 34a, 34b.

Furthermore, the arrangement 100 has a horizontal connecting piece 1 that connects a first partial guide housing 2 at a first horizontal end in ink-guiding manner to an ink supply 11. This ink supply 11 is here formed as a line 12 with line proportional valve 13. Furthermore, a gas supply 14 is also provided here, which is preferably designed as an air supply. The ink guiding device 110 also has a horizontal end piece 4, which closes off a last partial guide housing 2 at a second horizontal end.

The partial guide housings 2 each has a volume that can be filled partly with ink, here via the ink supply 11, and partly with gas here via the gas supply 14, an ink filling level and a gas pressure being adjustable. Each partial guide housing 2 is connected at its second horizontal end to a first horizontal end of a further partial guide housing 2 in an ink and gas connection or is connected to the end piece 4. The partial guide housings can be connected to one another by means of seals as the interfaces at their horizontal ends and/or by means of seals as the interface with the horizontal connecting piece and/or by means of seals as the interface with the horizontal end piece. In this embodiment, each partial guide housing 2 has a gas channel at its upper end. Furthermore, each partial guide housing 2 has an ink channel 25 at its lower end. The outlets 21 are guided from below through the ink channel 25 into an ink volume of the partial guide housing 2. The ink channel 25 has at one end directed toward the end piece 4 a passage to an ink volume of the partial guide housing 2.

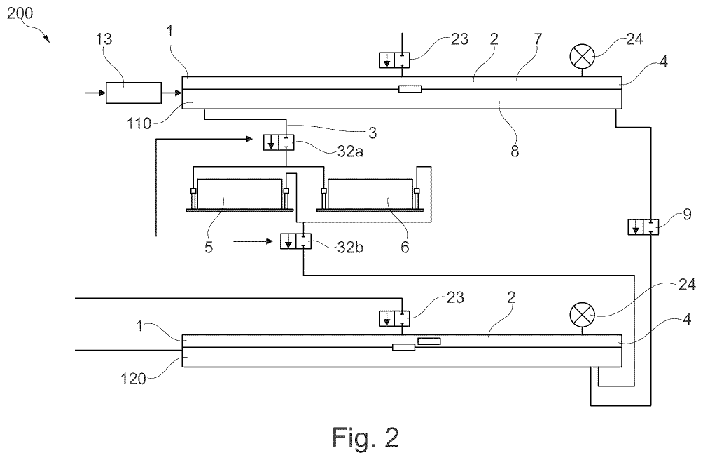

FIG. 2 shows a schematic flow chart representation of another embodiment of an arrangement according to the disclosure, which is designated here by 200.

This embodiment has two ink guiding devices 110 and 120. A first ink guiding device 110 is arranged to direct ink to two print heads 5, 6. A second ink guiding device 120 is arranged to discharge ink from the two print heads 5, 6. In this embodiment, the two ink guiding devices 110, 120 each has only one partial guide housing 2. The ink guiding device 110 is partly filled with ink 8 at its lower end and partly filled with gas 7 at its upper end. Each of the two ink guiding devices 110 and 120 has a capacitive pressure regulator 23 or pressure sensor and a fill level measurement device 24 or fill level sensor. By means of a line proportional valve 13, an ink supply to the first ink guiding device 110 is controlled as a function of the level measurement 24.

A lower connecting piece 3 is provided on the partial guide housing 2 of the first ink guiding device 110 and connects the partial guide housing 2 to the two print heads 5, 6 in ink-guiding manner underneath. The connecting piece 3 has a connecting valve 32a which controls an ink flow to the two print heads 5, 6.

A second ink guiding device 120 is arranged to discharge ink from the two print heads 5, 6. Furthermore, between the first ink guiding device 110 and the second ink guiding device 120, a further valve 9 is provided that allows a flow of ink from the first ink guiding device 110 directly to the second ink guiding device 120. In this way, a certain flow can advantageously be generated and maintained independently of a printing process, so that the ink does not lose its quality by being stationary.

The further valve 9 is arranged here between the end piece 4 of the first ink guiding device 110 and the end piece of the second ink guiding device 120. In this way, a flow direction of ink in the second ink guiding device 120 is exactly opposite to a flow direction of ink in the first ink guiding device 110.

Also provided on the second ink guiding device 120 is a lower connecting piece 3 that connects underneath the partial guide housing 2 with the two print heads 5, 6 in ink-guiding manner. The connecting piece 3 has a connecting valve 32b that controls an ink flow from the two print heads 5, 6.

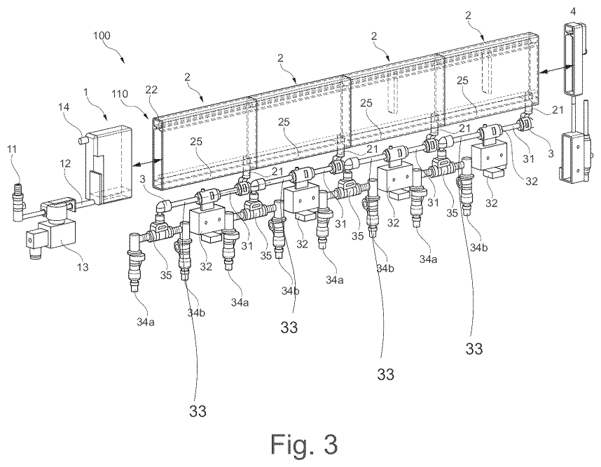

FIG. 3 shows the part of the ink guide device 110 from FIG. 1 differing in that exemplary four partial guide housings 2 are shown. The number of partial guide housings 2 in an ink guide device 110 is not limiting.

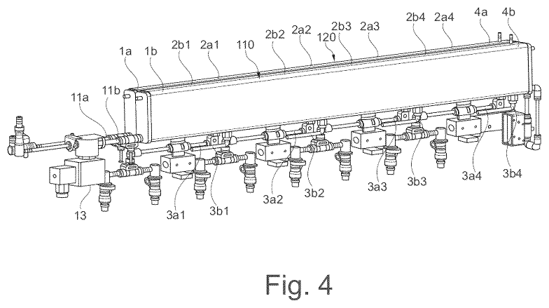

FIG. 4 shows a part of another embodiment of an arrangement for guiding ink from and to several print heads (not shown in this figure). Two ink guide devices 110, 120 in a parallel arrangement in a schematic perspective view are shown together. A first ink guide device 110 is arranged to guide ink to the print heads. A second ink guide device 120 is arranged to guide ink from the print heads.

The first ink guide device 110 includes four partial ink guide housings 2b1, 2b2, 2b3, 2b4. The second ink guide device 120 also includes four partial ink guide housings 2a1, 2a2, 2a3, 2a4. Furthermore, the first ink guide device 110 includes a horizontal connecting piece 1b, which connects a first partial ink guide housing 2b1 at its first horizontal end in an ink guiding manner with a first ink supply 11b, which is connected to a line proportional valve 13. Additionally, the first ink guide device 110 includes a horizontal end piece 4b, which completes a last partial guide housing 2b4 at its second horizontal end. The second ink guide device 120 also includes a horizontal connecting piece 1a, which, however, connects a first partial ink guide housing 2a1 at its horizontal end in an ink guiding manner with an ink discharge 11a. Additionally, the second ink guide device 120 includes a horizontal end piece 4a, which completes a last partial ink guide housing 2a4 at its second horizontal end. The partial ink guide housings 2b1, 2b2, 2b3, 2b4 of the first ink guide device 110 are formed integrally connected or welded with each other and with the horizontal connecting piece 1b and the horizontal end piece 4b. Also, the partial ink guide housings 2a1, 2a2, 2a3, 2a4 of the second ink guide device 120 are formed integrally connected with each other and with the horizontal connecting piece 1a and the horizontal end pieced 4a. The first ink guide device 110 and the second ink guide device 120 are arranged parallelly combined next to each other. In this way, supplying and discharging of ink may be achieved in a space saving manner.

Every partial ink guide housing 2b1, 2b2, 2b3, 2b4 of the first ink guide device 110 includes a lower connector 3b1, 3b2, 3b3, 3b4 that connects every partial guide housing 2b1, 2b2, 2b3, 2b4 beneath with two print heads (not shown). Also every partial ink guide housing 2a1, 2a2, 2a3, 2a4 of the second ink guide device 120 includes a lower connector 3a1, 3a2, 3a3, 3a4, which connects every partial ink guide housing 2a1, 2a2, 2a3, 2a4 beneath with two print heads in an ink guiding manner.

By the measure of designing the ink guiding devices in such a way that they can be filled partly with ink and partly with gas, a simplified solution for ink supply and/or removal from or to a print head is proposed, which advantageously combines the scalability with the cushioning of disturbances by pressure waves from the ink ejection.

Embodiments can be implemented as hardware (e.g. circuits, firmware, software or any combination thereof). Embodiments can also be implemented as instructions which are stored on a machine-readable medium which can be read and executed by one or more processors. A machine-readable medium can have any mechanism for storing and transmitting information which can be read by a machine (e.g. a computer). For the purposes of this discussion, the expression control unit should be understood as circuits or processor or combinations thereof including memory instructions. A circuit comprises an analog circuit, a digital circuit, a data processing circuit, other structural electronic hardware or a combination thereof. A processor comprises a microprocessor, a digital signal processor (DSP), a central processor (CPU), a processor (ASIP) set by application-specific instructions, a graphics and/or image processor, a multi-core processor or another hardware processor.

1. An arrangement for directing ink from and/or to one or more printheads of an ink jet printing system, the arrangement comprising:
one or more printheads; and
at least one ink guiding device adapted to direct ink from and/or to the one or more printheads, the at least one ink guiding device comprising:
a plurality of partial guide housings including a first partial guide housing and a last partial guide housing;
at least one lower connecting piece that connects underneath each partial guide housing with one or more of the print heads in an ink-guiding manner;
a horizontal connector connecting the first partial guide housing at a first horizontal end in an ink-guiding manner to an ink supply and/or an ink discharge; and
a horizontal end piece closing the last partial guide housing at a second horizontal end,
wherein each of the plurality of partial guide housings has a volume that can be filled partly with ink and partly with gas, an ink level height and a gas pressure being adjustable,
wherein each of the plurality of partial guide housings is connected at the second horizontal end to the first horizontal end of a further partial guide housing in an ink and gas connection or is connected to the horizontal end piece.

2. The arrangement according to claim 1, wherein the partial guide housings are connectable to one another with seals at their horizontal ends and/or by means of seals with the horizontal connecting piece and/or by means of seals with the horizontal end piece.

3. The arrangement according to claim 1, wherein the partial guide housings are welded or integrally formed integrally together and/or to be welded or formed integrally together with the horizontal connecting piece and/or with the horizontal end piece.

4. The arrangement according to claim 1, wherein the partial guide housings have a parallelepiped shape in which a horizontal width dimension is smaller than a vertical dimension.

5. The arrangement according to claim 1, wherein the partial guide housings are formed from plastic or a metal, in particular stainless steel.

6. The arrangement according to claim 1, wherein the ink guiding device has a sensor for determining an ink filling level, in particular a capacitive filling level sensor.

7. The arrangement according to claim 1, wherein the ink guiding device comprises one or more sensors for determining a gas pressure.

8. The arrangement according to claim 1, wherein the ink guiding device is configured as an ink supply having a horizontal connecting piece connected in ink-guiding manner to a proportional valve configured to control an ink passage speed in dependence on the gas pressure.

9. The arrangement according to claim 1, wherein the at least one lower connecting piece of each partial guide housing connects ink guiding with two print heads.

10. A system for printing ink on a recording medium comprising the assembly according to claim 1.
